(19) United States
(12) Patent Application Publication
(10) Pub. No.: US 2026/0242549 A1
(43) Pub. Date: Aug. 20, 2026

(54) Flexible Elastomeric Heat Insulating And Flame-Retardant Material And Preparation Methods Thereof

(71) Applicant: Poly-Nova Technologies Corporation, Guelph (CA)

(72) Inventor: Richard VALERIOTE, Guelph (CA)

(73) Assignee: Poly-Nova Technologies Corporation, Guelph, ON (CA)

(21) Appl. No.: 19/160,607

(22) PCT Filed: Jun. 10, 2024
(86) PCT No.: PCT/CA2024/050779

§ 371 Date: Aug. 28, 2025

Related U.S. Application Data
(60) Provisional application No. 63/472,362, filed on Jun. 12, 2023.

(51) Int. Cl. C08J 3/20; C08G 77/08; C08G 77/16; C08G 77/20; C08K 3/36; C08K 3/38; C08K 5/14; C08K 7/10; C08K 7/14; C08K 9/06

(52) U.S. Cl. CPC C08J 3/203; C08G 77/08; C08G 77/16; C08K 3/36; C08K 5/14; C08K 7/10; C08K 7/14; C08K 9/06; C08G 77/20; C08J 2383/04; C08K 2003/387; C08K 2201/011; C08K 2201/016

(57) ABSTRACT

A flexible elastomeric material with fire retardant and heat insulating properties, the material including: a) a siloxane gum from about 30-60% by weight (w/w) of the flexible elastomeric material; b) a silica reinforcing filler from about 5-30% w/w of the flexible elastomeric material; c) a silica extending filler from about 0-50% w/w of the flexible elastomeric material; d) a viscosity control agent from about 0-10% w/w of the flexible elastomeric material; e) a flux agent from about 1-25% w/w of the flexible elastomeric material; f) a glass fibre filler from about 5-40% w/w of the flexible elastomeric material; g) a hydrous aluminum silicate filler from about 5-30% w/w of the flexible elastomeric material; h) a silicon carbide filler from about 20-40% w/w of the flexible elastomeric material; and i) a peroxide crosslinker from about 0.1-0.6% w/w of the flexible elastomeric material.

### FIELD OF THE DISCLOSURE

The present disclosure relates to a flexible elastomeric heat insulating material resistant to breakthrough at a temperature from about 1200° C. for at least 30 minutes, its uses and preparation methods for same.

### BACKGROUND

Fully cross-linked ceramifiable silicone compositions do not have sufficient mechanical strength to withstand direct contact of an oxygen-propane flame at 1200° C. Further, standard ceramifiable silicones will not pass OEM or UL testing at 1200° C. and therefore are not accepted for use in preventing flame and smoke from passing from one cell of a lithium-ion battery to an adjacent cell. The silicone compositions lack mechanical strength under conditions of pyrolysis of the silicone elastomer. Furthermore, current composite materials are difficult to manufacture and are rigid in nature and not flexible and lack desirable viscoelastic properties as well as not able to provide sealing of mating components due to the lack of desirable viscoelastic properties. The current composite fire-retardant materials cannot mitigate secondary events post fire such as but not limited to explosions, for example, of electric vehicle (EV) power supply, thermal runaway of EV power supply, flame and/or smoke migration into an EV passenger compartment. Accordingly, it is desired to have a flexible elastomer material with heat resistant properties. It is also desired to have a flexible elastomer material with fire retardant and smoke migration suppressant properties. It is also desired to have a flexible elastomer material with sufficient mechanical strength to withstand breakthrough at high temperatures, for example, but not limited to 1200° C., preferably a flame of 1200° C. It is also desired to have a flexible elastomer material that is shapeable and that may be molded or extruded as required. It is also desired to have a flexible elastomer material with viscoelastic properties. It is also desired to have a homogeneous silicone material with fire resistance and burn through resistance at 1200° C. It is also desired to have a manufacturing method for a flexible elastomer material. It is also desirable to have a material that is able to be calendared onto fabric and die-cut. It is also desirable to have a material that may reduce noise and/or vibration when in contact with other materials and serve as an isolator and/or damper.

### BRIEF SUMMARY

The following will be used through the disclosure:

Silicone rubber compound is used interchangeably with flexible elastomeric material.

PDMVS: Polydimethylvinylsiloxane base is formed by a siloxane gum, a silica reinforcing filler and a viscosity control agent

Ablation: Removal or destruction of something from a material or object by vaporization or erosive process.

Aspect Ratio: Describes “rod like” particles and the ratio of length to diameter (L/D)

Aluminosilicate: Minerals composed of aluminum, silicon and oxygen plus countercations (Al₂O₃·SiO₂).

Breakthrough and Burn through are used interchangeably and refers to the compromising of the layer of the material such that the material fails in structural integrity.

Eutectic: Relating to or denoting a mixture of substances (in fixed proportions) that melts and solidifies at a single temperature that is lower than the melting points of the separate constituents or of any other mixture of them.

Flux Agent: A chemical which serves to lower the temperature at which a single material or a mixture of materials will melt.

Polymorphism: Is the term used to indicate the existence of the same chemical composition in two or more crystalline forms, each with its own vapor pressures, temperature range of stability and physical properties.

Andisil® H110-0 is a methyl vinyl silicone rubber (VMQ) with a terminal vinyl group and a molecular weight of 50-70 10⁴ a vinyl content of 0.03-0.07% and mmol/g of 0.0148.

Andisil® H101-8 is a methyl vinyl silicone rubber (VMQ) methyl terminated and with pendant vinyl groups only and a molecular weight of 45-65 10⁴ a vinyl content of 7.80-8.20% and a mmol/g of 2.9630.

Andisil® OH 40 silanol fluid is a silanol functional fluid with low viscosity 3.5% silanol fluid, with a kinematic viscosity of 40 centiStokes.

Andisil® C1142A Karsted Catalyst is an organoplatinum catalyst derived from divinyl-containing disiloxane catalyst.

Aerosil® 200 fumed silica filler is a hydrophilic fumed silica with a specific surface area of 200 m²/g.

Sidistar® R320 is a light-coloured spherically-shaped amorphous non-reinforcing silicon dioxide with an average primary particle size of 150 nm.

Rio Tinto Firebrake® ZB Fine is a flame retardant zinc borate hydrate.

Fibertec® Microglass 9132 is a microglass milled fiber as E-glass filaments with average fiber diameter of 16 microns, average fiber length of 220 microns, average aspect ratio of 12:1, average bulk density of 0.78+/−0.08 g/cubic centimeter, average moisture content of <0.1%, average loss on ignition of <0.08%, increasing mechanical properties, improving dimensional stability and minimizing distortion at elevated temperatures.

LKAB MicaFort® TX300-SA20 is ground muscovite treated with a functional silane and with a particle size distribution by wet sieving of BS Mesh No. 300 with a sieve aperture size of 53 microns, a cumulative % retained of from 0-0.1 and with a sieve aperture size of 20 microns, a cumulative % retained of from 0-10.

Haydale® SI-TUFF silicon carbide whiskers are a fibrous form of single-crystal silicon carbide having an aspect ratio of about 7:1, in one alternative of about 10:1, and yet in another alternative of about 15:1. Further the silicone carbide whiskers in one alternative have a chemical composition as a single crystal with a diamond cubic crystal structure, a geometry of high L/D rigid rod microfiber, a mean diameter of 0.65 μm, a medium length of 10-12 μm (D⁵⁰), a modulus of 450 GPa, a density of 3.21 g/cm³ and a hardness of 9.5 Mohs. The silicon carbide whiskers improves abrasion and scratch resistance, thermal conductivity, temperature stability, and hardness at low loading levels without affecting other desirable properties, including non-stick/release, flexibility, and low friction.

NYAD G® wollastonite is a high-performance mineral product derived from naturally occurring wollastonite, an acicular calcium inosilicate mineral. Known for its unique properties and versatile applications such as an inorganic ceramic filler, NYAD G® wollastonite is utilized across various industries to enhance product performance and improve manufacturing processes. NYAD G® wollastonite primarily consists of calcium silicate (CaSiO₃), which contributes to its physical and chemical properties. The product is finely ground, offering a uniform and consistent particle size distribution, which is crucial for achieving optimal performance in various applications. NYAD GR wollastonite has a high aspect ratio, meaning its particles are significantly longer than they are wide L/D ratio of 15:1 and a melting point of 1540° C. This attribute enhances its reinforcing properties. NYAD G® wollastonite exhibits excellent thermal stability, maintaining its structure and performance even at elevated temperatures. NYAD G® wollastonite has low moisture absorption, making it suitable for applications where water resistance is essential.

Varox® DBPH-50 is a peroxide accelerator chemically known as 2,5-dimethyl-2,5-di(t-butylperoxy) hexane for the vulcanization or crosslinking of most elastomers and polyolefins.

Andisil® XL-10 is a crosslinker reactive silicon-hydride containing polysiloxanes with random pendant silicon-hydride functionality and are trimethylsiloxyterminated that can be used in addition cure systems with Andisil platinum catalysts.

Andisil® MVC inhibitor is a polymerization inhibitor with chemical name tetramethyltetravinylcyclotetrasiloxane.

PPH parts per hundred of siloxane base.

According to one aspect, there is provided a flexible elastomeric material which mitigates, and preferably prevents flame and smoke from an unexpected combustion event from penetrating a passenger compartment in electric vehicles, railway cars and aircrafts.

According to one aspect, there is provided a flexible elastomeric material that meets UL94 Classification V-0.

According to another aspect, there is provided a flexible elastomeric material that provides a seal prior to a thermal event.

According to one aspect, there is provided a silicone rubber compound capable of withstanding exposure to a 1200° C. oxyacetylene flame without ignition or mechanical failure. The oxyacetylene flame is blocked through the creation of a glass/ceramic “eutectic liquid” layer on the silicone rubber compound at the point of contact with the 1200° C. flame.

According to another aspect, there is provided a fire retardant and heat insulating elastomer which forms a glass/aluminosilicate hybrid structure when the fire retardant and heat insulating elastomer is exposed to a 1200° C. flame. The melting point of both the glass and ceramic fillers used in the silicone rubber compound described herein is reduced through the use of a zinc borate flux agent.

When the silicone rubber compound described herein is exposed to 1200° C., the refractory and glass additives utilized in the silicone rubber compound are converted to a eutectic aluminosilicate mixture. Under these extreme temperature conditions, the eutectic aluminosilicate mixture exhibits excellent mechanical properties due in part to the incorporation of silicon carbide whiskers, in one alternative 15% by weight, into the silicone rubber compound, and in an alternative, due in part to the incorporation of a combination of wollastonite and silicon carbide whiskers, in one alternative in a ratio of from about 0:30 to 10:20 PPH of wollastonite: silicon carbide whiskers, into the silicone rubber compound, and in another alternative in a ratio of from about 30:0 to 0:30 PPH of wollastonite: silicon carbide whiskers.

The silicone rubber compound described herein may be formulated with either peroxide or addition cure systems.

Components as thin as 0.8 millimeters with intricate undercuts may be injection molded from the silicone rubber compounds described herein.

Under temperature conditions which can cause “auto ignition” of the silicone, a robust glass/aluminosilicate ceramic eutectic mixture is formed which has high mechanical strength as well as excellent dielectric properties and low thermal conductivity.

The silicone rubber compounds described herein retain all of the properties of a standard silicone elastomer such as resistance to cold, resistance to high temperature, compression set resistance, and surface properties such as hydrophobicity.

The dielectric properties of the silicone rubber compounds described herein are enhanced by the addition of ceramic and glass fillers in the compounds and the dielectric properties are maintained after ablation and the formation of the ceramic layer.

According to one alternative, there is provided a flexible elastomeric material prior to curing as follows:

| | Parts | | | |
|---|---|---|---|---|
| | Per | | Primary | |
| | Hundred | Weight | Chemical | Refractory |
| Ingredient | PPH | % | Elements | Function |
| PDMVS Base | 100 | 48.8% | Silicon, | Yields SiO₂ |
| | | | Oxygen, | upon pyrolysis |
| | | | Carbon, | |
| | | | Hydrogen | |
| Zinc Borate | 15 | 7.32% | Zinc, | Ceramic Flux |
| | | | Boron, | Agent-lowers |
| | | | Oxygen | melting point |
| | | | | of glass |
| Fibertec ® | 20 | 9.76% | Oxides of | In Eutectic |
| 9132 Glass | | | Silicon, | mixture causes |
| | | | Calcium, | crystalline |
| | | | Aluminum, | phases to bond |
| | | | Magnesium, | together |
| | | | Boron | |
| Muscovite Mica | 40 | 19.51% | Silicon, | Source of Silicon, |
| LKAB SA20 | | | Aluminum, | Aluminum |
| | | | Potassium, | |
| | | | Iron | |
| Silicon Carbide | 30 | 14.63% | Silicon, | Provides structural |
| Whiskers | | | Carbon | strength to |
| Haydale ® | | | | eutectic ceramic |
| SF-1 | | | | mixture |
| | 205 | | | |

According to another alternative, there is provided a flexible elastomeric material prior to curing as follows:

| | Parts | | | |
|---|---|---|---|---|
| | Per | | Primary | |
| | Hundred | Weight | Chemical | Refractory |
| Ingredient | PPH | % | Elements | Function |
| PDMVS Base | 100 | 48.8% | Silicon, | Yields SiO₂ |
| | | | Oxygen, | upon pyrolysis |
| | | | Carbon, | |
| | | | Hydrogen | |
| Zinc Borate | 15 | 7.32% | Zinc, Boron, | Ceramic Flux |
| | | | Oxygen | Agent-lowers |
| | | | | melting point |
| | | | | of glass |
| Fibertec ® | 20 | 9.76% | Oxides of | In Eutectic |
| 9132 Glass | | | Silicon, | mixture causes |
| | | | Calcium, | crystalline |
| | | | Aluminum, | phases to bond |
| | | | Magnesium, | together |
| | | | Boron | |
| Muscovite Mica | 40 | 19.51% | Silicon, | Source of Silicon, |
| LKAB SA20 | | | Aluminum, | Aluminum |
| | | | Potassium, | |
| | | | Iron | |
| Silicon Carbide | 30 | 14.63% | Silicon, | Provides structural |
| Whiskers | | | Carbon | strength |
| Haydale ® | | | | to eutectic |
| SF-1: Wollastonite | | | | ceramic mixture |
| Nyad G ® | | | | |
| composition of | | | | |
| ratio of from about | | | | |
| 30:0 to 20:10 PPH | | | | |
| | 205 | | | |

According to another alternative, there is provided a flexible elastomeric material prior to curing as follows:

| | Parts | | | |
|---|---|---|---|---|
| | Per | | Primary | |
| | Hundred | Weight | Chemical | Refractory |
| Ingredient | PPH | % | Elements | Function |
| PDMVS Base | 100 | 48.8% | Silicon, | Yields SiO₂ |
| | | | Oxygen, | upon pyrolysis |
| | | | Carbon, | |
| | | | Hydrogen | |
| Zinc Borate | 15 | 7.32% | Zinc, Boron, | Ceramic Flux |
| | | | Oxygen | Agent-lowers |
| | | | | melting point |
| | | | | of glass |
| Fibertec ® | 20 | 9.76% | Oxides of | In Eutectic |
| 9132 Glass | | | Silicon, | mixture causes |
| | | | Calcium, | crystalline |
| | | | Aluminum, | phases to bond |
| | | | Magnesium, | together |
| | | | Boron | |
| Muscovite Mica | 40 | 19.51% | Silicon, | Source of Silicon, |
| LKAB SA20 | | | Aluminum, | Aluminum |
| | | | Potassium, | |
| | | | Iron | |
| Silicon Carbide | 30 | 14.63% | Silicon, | Provides structural |
| Whiskers | | | Carbon | strength |
| Haydale ® | | | | to eutectic |
| SF-1: Wollastonite | | | | ceramic mixture |
| Nyad G ® | | | | |
| composition of | | | | |
| ratio of from about | | | | |
| 0:30 to 30:0 PPH | | | | |
| | 205 | | | |

According to one alternative, there is provided a flexible elastomeric material comprising:
a. at least one siloxane gum from about 30-60% by weight (w/w) of said flexible elastomeric material;
b. at least one silica reinforcing filler from about 5-30% w/w of said flexible elastomeric material;
c. at least one silica extending filler from about 0-50% w/w of said flexible elastomeric material;
d. at least one viscosity control agent from about 0.5-10% w/w of said flexible elastomeric material;
e. at least one flux agent from about 1-25% w/w of said flexible elastomeric material;
f. at least one glass fibre filler from about 5-40% w/w of said flexible elastomeric material;
g. at least one hydrous aluminum silicate filler from about 5-30% w/w of said flexible elastomeric material;
h. at least one silicon carbide filler from about 20-40% w/w of said flexible elastomeric material, in one alternative at least one filler from about 20-40% w/w of said flexible elastomeric material, comprising silicon carbide and wollastonite in a ratio of from about 30:0 to 20:10 PPH of silicon carbide: wollastonite, and in another alternative in a ratio of from about 30:0 to 0:30 PPH of silicon carbide: wollastonite; and
i. at least one peroxide crosslinker from about 0.1-0.6% w/w of said flexible elastomeric material;
   wherein ingredients a (at least one siloxane gum), b (at least one silica reinforcing filler) and d (at least one viscosity control agent) form a siloxane base that may be used as a starting material for the manufacture of the flexible elastomeric material as described herein.

According to another alternative, there is provided a flexible elastomeric material comprising:
a. at least one siloxane gum from about 30-60% by weight (w/w) of said flexible elastomeric material;
b. at least one nano silica reinforcing filler from about 5-30% w/w of said flexible elastomeric material;
c. at least one silica extending filler from about 0-30% w/w of said flexible elastomeric material;
d. at least one viscosity control agent from about 0.5-10% w/w of said flexible elastomeric material;
e. at least one flux agent from about 1-25% w/w of said flexible elastomeric
f. at least one glass fibre filler from about 5-40% w/w of said flexible elastomeric material;
g. at least one hydrous aluminum silicate filler from about 5-30% w/w of said flexible elastomeric material;
h. at least one silicon carbide filler from about 5-30% w/w of said flexible elastomeric material, in one alternative at least one filler from about 5-30% w/w of said flexible elastomeric material, comprising silicon carbide and wollastonite in a ratio of from about 30:0 to 20:10 PPH of silicon carbide: wollastonite, and in another alternative in a ratio of from about 30:0 to 0:30 PPH of silicon carbide: wollastonite;
i. at least one methyl hydrogen fluid crosslinker from about 0.01-0.05% w/w of said flexible elastomeric material;
j. at least one platinum complex catalyst from about 0.01-0.05% w/w of said flexible elastomeric material; and
k. at least one cure inhibitor from about 0.02-0.06% w/w of said flexible elastomeric material, wherein a., b., and c. form a siloxane base of said flexible elastomeric material.

According to one alternative, there is provided a flexible elastomeric material comprising:
a. at least one siloxane gum from about 38-48% by weight (w/w) of said flexible elastomeric material;
b. at least one silica reinforcing filler from about 10-20% w/w of said flexible elastomeric material;
c. at least one silica extending filler from about 0-30% w/w of said flexible elastomeric material;
d. at least one viscosity control agent from about 0.5-5% w/w of said flexible elastomeric material;
e. at least one flux agent from about 3-15% w/w of said flexible elastomeric material;
f. at least one glass fibre filler from about 5-15% w/w of said flexible elastomeric material;
g. at least one hydrous aluminum silicate filler from about 5-20% w/w of said flexible elastomeric material;
h. at least one silicon carbide filler from about 5-15% w/w of said flexible elastomeric material, in one alternative at least one filler from about 5-15% w/w of said flexible elastomeric material, comprising silicon carbide and wollastonite in a ratio of from about 30:0 to 20:10 PPH of silicon carbide: wollastonite, and in another alternative in a ratio of from about 30:0 to 0:30 PPH of silicon carbide: wollastonite; and
i. at least one peroxide crosslinker from about 0.2-0.4% w/w of said flexible elastomeric material, wherein a., b., and c. form a siloxane base of said flexible elastomeric material.

According to another alternative, there is provided a flexible elastomeric material comprising:
a. at least one siloxane gum from about 38-48% by weight (w/w) of said flexible elastomeric material;
b. at least one silica reinforcing filler from about 10-20% w/w of said flexible elastomeric material;
c. at least one viscosity control agent from about 0.5-30% w/w of said flexible elastomeric material;
d. at least one flux agent from about 1-5% w/w of said flexible elastomeric material;
e. at least one glass fibre filler from about 5-15% w/w of said flexible elastomeric material;
f. at least one hydrous aluminum silicate filler from about 5-20% w/w of said flexible elastomeric material;
g. at least one silicon carbide filler from about 5-15% w/w of said flexible elastomeric material, in one alternative at least one filler from about 5-15% w/w of said flexible elastomeric material, comprising silicon carbide and wollastonite in a ratio of from about 30:0 to 20:10 PPH of silicon carbide: wollastonite, and in another alternative in a ratio of from about 30:0 to 0:30 PPH of silicon carbide: wollastonite;
h. at least one methyl hydrogen polysiloxane crosslinker from about 1.5-3.0% w/w of said flexible elastomeric material;
i. at least one platinum complex catalyst from about 0.015-0.03% w/w of said flexible elastomeric material; and
j. at least one cure inhibitor from about 0.02-0.04% w/w of said flexible elastomeric material, wherein a., b., and c. form a siloxane base of said flexible elastomeric material.

According to one alternative, there is provided a flexible elastomeric material comprising:
a. at least one siloxane gum from about 42% by weight (w/w) of said flexible elastomeric material;
b. at least one nano silica reinforcing filler from about 12% w/w of said flexible elastomeric material;
c. at least one viscosity control agent from about 2.1% w/w of said flexible elastomeric material;
d. at least one flux agent from about 6% w/w of said flexible elastomeric material;
e. at least one glass fibre filler from about 8% w/w of said flexible elastomeric material;
f. at least one hydrous aluminum silicate filler from about 17% w/w of said flexible elastomeric material;
g. at least one silicon carbide filler from about 12% w/w of said flexible elastomeric material, in one alternative at least one filler from about 12% w/w of said flexible elastomeric material, comprising silicon carbide and wollastonite in a ratio of from about 30:0 to 20:10 PPH of silicon carbide: wollastonite, and in another alternative in a ratio of from about 30:0 to 0:30 PPH of silicon carbide: wollastonite; and
h. at least one peroxide crosslinker from about 0.3% w/w of said flexible elastomeric material, wherein a., b., and c. form a siloxane base of said flexible elastomeric material.

According to another alternative, there is provided a flexible elastomeric material comprising:
a. at least one siloxane gum from about 41% by weight (w/w) of said flexible elastomeric material;
b. at least one nano silica reinforcing filler from about 12% w/w of said flexible elastomeric material;
c. at least one viscosity control agent from about 2% w/w of said flexible elastomeric material;
d. at least one flux agent from about 6% w/w of said flexible elastomeric material;
e. at least one glass fibre filler from about 8% w/w of said flexible elastomeric material;
f. at least one hydrous aluminum silicate filler from about 16% w/w of said flexible elastomeric material;
g. at least one silicon carbide filler from about 12% w/w of said flexible elastomeric material, in one alternative at least one filler from about 12% w/w of said flexible elastomeric material, comprising silicon carbide and wollastonite in a ratio of from about 30:0 to 20:10 PPH of silicon carbide: wollastonite, and in another alternative in a ratio of from about 30:0 to 0:30 PPH of silicon carbide: wollastonite;
h. at least one methyl hydrogen fluid crosslinker from about 2.0% w/w of said flexible elastomeric material;
i. at least one platinum complex catalyst from about 0.02% w/w of said flexible elastomeric material; and
j. at least one cure inhibitor from about 0.04% w/w of said flexible elastomeric material, wherein a., b., and c. form a siloxane base of said flexible elastomeric material.

According to one alternative, there is provided a flexible elastomeric material comprising:
a. A polydiorganosiloxane gum from about 30-60%, in one alternative from about 38-48%, by weight (w/w) of said flexible elastomeric material, said polydiorganosiloxane gum comprising organic radicals selected from the group consisting of methyl, vinyl, phenyl, 3,3,3-trifluoropropyl and mixtures thereof;
b. at least one fumed process nano particle silica filler (SiO₂) from about 5-30%, in one alternative from about 10-20%, w/w of said flexible elastomeric material;
c. at least one ground silica filler (SiO₂) from about 0-30% w/w of said flexible elastomeric material, wherein a., b., and c. form a siloxane base of said flexible elastomeric material;
d. at least one hydroxyl terminated silanol fluid (40cst) from about 0-10%, in one alternative from about 1-5%, w/w of said flexible elastomeric material;
e. at least one high surface area from about 2-15 square meters per gram metal oxide from about 1-25%, in one alternative from about 3-15%, w/w of said flexible elastomeric material, wherein said at least one high surface area from about 2-15 square meters per gram metal oxide has waters of hydration, preferably selected from the group consisting of alumina trihydrate, magnesium dihydroxide, zinc borate and combinations thereof;
f. at least one E-glass filament from about 5-40%, in one alternative from about 5-15%, w/w of said flexible elastomeric material;
g. at least one of ground muscovite, phlogopite mica and combinations thereof from about 5-30%, in one alternative from about 5-20%, w/w of said flexible elastomeric material;
h. silicon carbide whiskers from about 5-30%, in one alternative from about 5-15%, w/w of said flexible elastomeric material, in one alternative said silicon carbide whiskers are substituted with a combination of silicon carbide whisker: wollastonite in a ratio of from about 30:0 to 20:10 PPH, and in another alternative in a ratio of from about 30:0 to 0:30 PPH of silicon carbide whiskers:wollastonite;
i. at least one cure system selected from
   1. a peroxide 2,5 dimethyl, 2,5 di (t-butyl peroxy)-hexane) from about 0.1-0.5%, in one alternative from about 0.2-0.4%, w/w of said flexible elastomeric material, and in another alternative 2, 4 dichlorobenzoyl peroxide from about 0.3-0.6% w/w, and in another alternative 2, 4 dichlorobenzoyl peroxide from about 0.6-0.9% w/w; or an addition cure system selected from the combination of the group consisting of:
   2. platinum cyclovinylmethylsiloxane complex (Karsted Catalyst) from about 0.01-0.05% w/w of said flexible elastomeric material;
   3. hydride terminated polydimethyl siloxane from about 1.0-5.0%, in one alternative from about 1.5-3.0%, w/w of said flexible elastomeric material;
   4. 1,3,5,7-tetravinyl-cyclotetrasiloxane from about 0.02-0.06% w/w of said flexible elastomeric material.

According to one alternative, there is provided a flexible elastomeric material comprising:
a. A polydiorganosiloxane gum from about 42% by weight (w/w) of said flexible elastomeric material, said polydiorganosiloxane gum comprising organic radicals selected from the group consisting of methyl, vinyl, phenyl, 3,3,3-trifluoropropyl and mixtures thereof;
b. at least one fumed process nano particle silica filler (SiO₂) from about 12% w/w of said flexible elastomeric material;
c. at least one hydroxyl terminated silanol fluid (40cst) from about 2.1% w/w of said flexible elastomeric material, wherein a., b., and c. form a siloxane base of the flexible elastomeric material;
d. at least one high surface area from about 2-15 square meters per gram metal oxide from about 6% w/w of said flexible elastomeric material, wherein said at least one high surface area from about 2-15 square meters per gram metal oxide has waters of hydration, preferably selected from the group consisting of alumina trihydrate, magnesium dihydroxide, zinc borate and combinations thereof;
e. at least one E-glass filament from about 8% w/w of said flexible elastomeric material;
f. at least one of ground muscovite, phlogopite mica and combinations thereof from about 17% w/w of said flexible elastomeric material; wherein the ground muscovite, phlogopite mica and combinations thereof, in one alternative have a particle size distribution by wet sieving of BS Mesh No. 300 with a sieve aperture size of 53 microns, a cumulative % retained of from 0-0.1 and with a sieve aperture size of 20 microns, a cumulative % retained of from 0-10;
g. silicon carbide whiskers from about 12% w/w of said flexible elastomeric material, in one alternative said silicon carbide whiskers are substituted with a combination of silicon carbide whisker: wollastonite in a ratio of from about 30:0 to 20:10 PPH, and in another alternative in a ratio of from about 30:0 to 0:30 PPH of silicon carbide whiskers:wollastonite;
h. at least one cure system selected from 2,5 dimethyl, 2,5 di (t-butyl peroxy)-hexane) from about 0.3% w/w of said flexible elastomeric material, or as an alternative 2,4 dichlorobenzoyl peroxide 0.6% w/w; or an addition cure system selected from the combination of the group consisting of:
   i. platinum cyclovinylmethylsiloxane complex (Karsted Catalyst) from about 0.01-0.05% w/w of said flexible elastomeric material;
   ii. hydride terminated polydimethyl siloxane from about 1.5-3.0%, w/w of said flexible elastomeric material;
   iii. 1,3,5,7-tetravinyl-cyclotetrasiloxane from about 0.02-0.06% w/w of said flexible elastomeric material.

According to one alternative, there is provided a flexible elastomeric material comprising:
a. Andisil® H110-0 0.04% mole % vinyl siloxane gum from about 29-58%, in one alternative from about 38-48%, by weight (w/w) of said flexible elastomeric material;
b. Andisil® H101-8 8 mole % vinyl siloxane gum from about 1-4%, in one alternative from about 1-3%, w/w of said flexible elastomeric material;
c. Aerosil® 200 fumed silica filler (SiO₂) from about 5-30%, in one alternative from about 10-20%, w/w of said flexible elastomeric material;
d. Sidistar® R320 amorphous SiO₂ from about 0-30% w/w of said flexible elastomeric material;
e. Andisil® OH-40 Silanol fluid from about 0.5-10%, in one alternative from about 1-5%, w/w of said flexible elastomeric material, wherein a., b., c., d., and e. form a siloxane base of the flexible elastomeric material;
f. Rio Tinto Firebrake® ZB Fine zinc borate from about 1-25%, in one alternative from about 3-15%, w/w of said flexible elastomeric material;
g. Fibertec® Microglass 9132 E-glass filament from about 5-40%, in one alternative from about 5-15%, w/w of said flexible elastomeric material;
h. LKAB MicaFort® TX300-SA20 silane treated muscovite mica from about 5-30%, in one alternative from about 5-20%, w/w of said flexible elastomeric material;
i. Haydale® SI-TUFF silicon carbide whiskers from about 5-30%, in one alternative from about 5-15%, w/w of said flexible elastomeric material, in another alternative said Haydale® SI-TUFF silicon carbide whiskers are substituted with a combination of Haydale® SI-TUFF silicon carbide whiskers: Nyad G® wollastonite in a ratio of from about 30:0 to 20:10 PPH, and in another alternative in a ratio of from about 30:0 to 0:30 PPH of Haydale® SI-TUFF silicon carbide whiskers: Nyad G® wollastonite;
j. A cure system selected from Varox® DBPH-50 peroxide from about 0.1-0.5%, in one alternative from about 0.2-0.4%, w/w of said flexible elastomeric material;
or an addition cure system selected from a combination from the group consisting of:
   i. Andisil® C1142A Karsted Catalyst from about 0.01-0.05% w/w of said flexible elastomeric material;
   ii. Andisil® XL-10 crosslinker from about 1.0-5.0%, in one alternative from about 1.5-3.0%, w/w of said flexible elastomeric material;
   iii. Andisil® MVC inhibitor from about 0.02-0.06% w/w of said flexible elastomeric material

According to one alternative, there is provided a flexible elastomeric material comprising:
a. Andisil® H110-0 0.04% mole % vinyl siloxane gum from about 40% by weight (w/w) of said flexible elastomeric material;
b. Andisil® H101-8 8 mole % vinyl siloxane gum from about 2% w/w of said flexible elastomeric material;
c. Aerosil® 200 fumed silica filler (SiO₂) from about 12% w/w of said flexible elastomeric material;
d. Andisil® OH-40 Silanol fluid from about 2.1% w/w of said flexible elastomeric material, wherein a., b., c., and d. form a siloxane base of the flexible elastomeric material;
e. Rio Tinto Firebrake® ZB Fine zinc borate from about 6% w/w of said flexible elastomeric material;
f. Fibertec® Microglass 9132 E-glass filament from about 8% w/w of said flexible elastomeric material;
g. LKAB MicaFort® TX300-SA20 silane treated muscovite mica from about 17% w/w of said flexible elastomeric material;
h. Haydale® SI-TUFF silicon carbide whiskers from about 12% w/w of said flexible elastomeric material, in another alternative said Haydale® SI-TUFF silicon carbide whiskers are substituted with a combination of Haydale® SI-TUFF silicon carbide whiskers: Nyad G® wollastonite in a ratio of from about 30:0 to 20:10 PPH, and in another alternative in a ratio of from about 30:0 to 0:30 PPH of Haydale® SI-TUFF silicon carbide whiskers: Nyad G® wollastonite; and
i. A cure system selected from Varox® DBPH-50 peroxide from about 0.3% w/w of said flexible elastomeric material; or
j. at least one addition cure system selected from a combination from the group consisting of:
   i. Andisil® C1142A Karsted Catalyst from about 0.01-0.05% w/w of said flexible elastomeric material;
   ii. Andisil® XL-10 crosslinker from about 1.0-3.0%, in one alternative from about 1.5-3.0%, w/w of said flexible elastomeric material;
   iii. Andisil® MVC inhibitor from about 0.02-0.06% w/w of said flexible elastomeric material.

According to another aspect there is provided a silicone rubber based ablative composite material.

In one alternative the silicone rubber based ablative composite material is resistant to thermochemical corrosion. In another alternative the silicone rubber based ablative composite material is resistant to mechanical scouring. In another alternative the silicone rubber based ablative composite material is resistant to thermal stress caused by high-speed heat flux at high temperatures (4570 Kilowatt/m²).

According to one aspect there is provided a process to manufacture a flexible elastomeric material according to any of the above.

According to one aspect, there is provided a process to manufacture a flexible elastomeric material, said process comprising the steps of:
a. introducing a siloxane gum of a predetermined amount to a mixer;
b. adding a viscosity control agent of a predetermined amount to the mixer;
c. allowing the viscosity control agent to disperse throughout the siloxane gum forming a siloxane gum-control agent mixture;
d. adding a silica reinforcing filler of a predetermined amount to the siloxane gum-control agent mixture until dispersed, wherein a., b., c., and d. form a siloxane base;
e. adding a flux agent of a predetermined amount, a glass fibre filler of a predetermined amount, a hydrous aluminum silicate filler of a predetermined amount, and a silicon carbide filler of a predetermined amount, in one alternative said silicon carbide filler is substituted with a silicon carbide: wollastonite combination filler in a ratio of from about 30:0 to 20:10 PPH, and in another alternative in a ratio of from about 30:0 to 0:30 PPH of silicon carbide: wollastonite;
f. allowing for mixing of the mixtures of steps d. and e. forming a mixture f.;
g. adding a peroxide crosslinker of a predetermined amount to the mixture of f. forming a mixture g.;
h. retrieving the mixture g. from the mixer in sheet form, preferably allowing the mixture g. to rest for about 24 hours for a mixture h.;
i. forming the mixture h. into at least one sheet of a predetermined thickness, preferably between about 2.5 and 3.0 millimeters and a predetermined weight, preferably between about 70 and 80 grams forming a sheet i.;
j. place sheet i. in a mold under a predetermined pressure, preferably a hydraulic pressure with a total clamp tonnage of 15-30 tons, and a predetermined crosslinking temperature, preferably about 175° Celsius (C) for a predetermined period of time, preferably between 10 and 20 minutes, allowing crosslinking and curing to occur forming a crosslinked cured mixture;
k. allowing the crosslinked cured mixture to cool, preferably cooled to room temperature;
l. post curing the cooled crosslinked cured mixture of step k. at a predetermined post curing temperature, preferably at about 200° C., and a predetermined post curing time of about 2 to 4 hours removing any volatile oligomer and complete curing of the cooled crosslinked cured mixture of step k.

According to one alternative, the process comprises starting with a siloxane base compound comprising a siloxane gum, a silica reinforcing filler and a viscosity control agent and proceeding at step e. In one alternative the siloxane base is allowed to rest for about 24-48 hours prior to commencing at step e.

According to yet another alternative, the process comprises starting with a siloxane base compound comprising a siloxane gum and a pre-treated silica reinforcing filler. In one alternative, the pre-treated silica reinforcing filler is a silica reinforcing filler treated with hexamethyldisilazane (HMDS) and proceeding at step e. In one alternative the siloxane base is allowed to rest for about 24-48 hours prior to commencing at step e.

According to yet another alternative, the peroxide crosslinker of step g is replaced by an addition cure system selected from a combination from the group consisting of Andisil® C1142A Karsted Catalyst from about 0.01-0.05% w/w of said flexible elastomeric material; Andisil® XL-10 crosslinker from about 1.0-3.0%, in one alternative from about 1.5-3.0%, w/w of said flexible elastomeric material; and Andisil® MVC inhibitor from about 0.02-0.06% w/w of said flexible elastomeric material.

According to one alternative, the mixer is a two-roll mixing mill.

According to one alternative, the two-roll mixing mill comprises two mixing rolls.

According to one alternative, at least one of the two mixing rolls is temperature controlled, preferably controlled such that the temperature of any mixture of steps a. to g. does not exceed about 60° C.

According to one alternative, any of the predetermined amounts are based on parts per hundred of the predetermined amount of siloxane gum introduced in step a.

According to one alternative, the predetermined amount of the silica enhancing agent is from about 200 square meters per gram of surface area of the siloxane gum-control agent mixture.

According to one alternative, the process further comprises cross-blending of the mixture f. In one alternative, said cross-blending is repeated. In another alternative, said cross-blending is repeated from about 6-8 times.

According to one alternative, the process further comprises cross-blending of the mixture g. In one alternative, said cross-blending is repeated. In another alternative, said cross-blending is repeated from about 6-8 times.

According to one alternative, the process further comprises adding a colour pigment in step g.

According to one alternative, step g. comprises in lieu of the peroxide crosslinker adding a predetermined amount of at least one of the following; a hydride crosslinker, a cure inhibitor, a platinum catalyst and combinations thereof.

According to one aspect, there is provided a flexible elastomeric material according to the above with the following characteristics:
a. specific gravity of from about 1.61 to1.62;
b. Shore A durometer hardness of from about 73 to 75 as per ASTM D2240;
c. Tensile strength of from about 3.7 to 5.3 Mega Pascals (MPa) as per ASTM D412;
d. Elongation as per ASTM D412 at break of from about 121% to 334.1%, wherein elongation at break refers to a measurement that shows how much the flexible elastomeric material can be stretched as a percentage of its original dimensions before it breaks;
e. Modulus at 100% at elongation as per ASTM D412 of from about 5.1 to 3.0 MPa;
f. Tear strength as per ASTM D624 “B” of from about 14.9 to 22.8 kiloNewtons per metre (kNm⁻¹); and
g. Breakthrough resistance at 1200° C. for 30 minutes.

According to another aspect, there is provided a flexible elastomeric material according to the above with the following characteristics:
a. specific gravity of from about 1.61 to1.62;
b. Shore A durometer hardness of from about 70 to 71 as per ASTM D2240;
c. Tensile strength of from about 4.6 to 5.5 Mega Pascals (MPa) as per ASTM D412;
d. Elongation as per ASTM D412 at break of from about 88% to 147%, wherein elongation at break refers to a measurement that shows how much the flexible elastomeric material can be stretched as a percentage of its original dimensions before it breaks;
e. Modulus at 100% at elongation as per ASTM D412 of from about 4.3 MPa;
f. Tear strength as per ASTM D624 “B” of from about kiloNewtons per metre (kNm⁻¹); and
g. Breakthrough resistance at 1200° C. for 30 minutes.

### BRIEF DESCRIPTION OF THE DRAWINGS

FIG. 1 is a photograph of a slab of the flexible elastomeric material, according to one alternative.

FIG. 2 is a photograph of the side of the slab of the flexible elastomeric material exposed to a 1200° C. flame.

FIG. 3 is a photograph of the side of the slab of the flexible elastomeric material opposite the side exposed to a 1200° C. flame.

FIG. 4 depicts a typical random chain breaking reactions of the flexible elastomeric material according to one alternative.

FIG. 5 depicts the degradation of PDMVS by the externally catalyzed mechanism.

FIG. 6 depicts the decomposition mechanism of the flexible elastomeric material according to one alternative.

FIG. 7 depicts the mechanism to form the eutectic mixture of the flexible elastomeric material according to one alternative.

FIG. 8 depicts the chemical structure of the aluminosilicate eutectic mixture, according to one alternative.

FIG. 9 depicts the aluminosilicate binary system phase diagram.

FIG. 10 depicts the chemical structure of the glass eutectic mixture.

FIG. 11 depicts the SiO₂ polymorphic eutectic phase diagram.

FIG. 12 depicts the repeating units of the polytriborate chain.

FIG. 13 depicts a scanning electron microscope (SEM) photograph of silicon carbide whiskers.

FIGS. 14a, 14b and 14c depict a SEM photograph of the surface of the flexible elastomeric material prior to exposure to a 1200° C. oxyacetylene flame according to one alternative.

FIG. 15 depicts a SEM photograph of the surface of the flexible elastomeric material at the point of exposure to the 1200° C. oxyacetylene flame according to one alternative.

FIG. 16 depicts a chart of the cold side surface temperature of the flexible elastomeric material undergoing a burn through test.

FIG. 17 depicts a wollastonite crystal under magnification.

FIG. 18 depicts wollastonite and silicon carbide in the flexible elastomeric material post curing.

### DETAILED DESCRIPTION

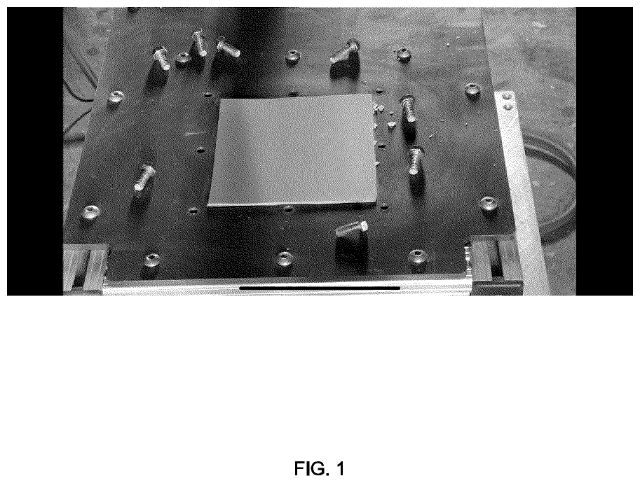

Referring now to FIG. 1, there is depicted a flexible elastomeric material according to one alternative in the shape of a sheet.

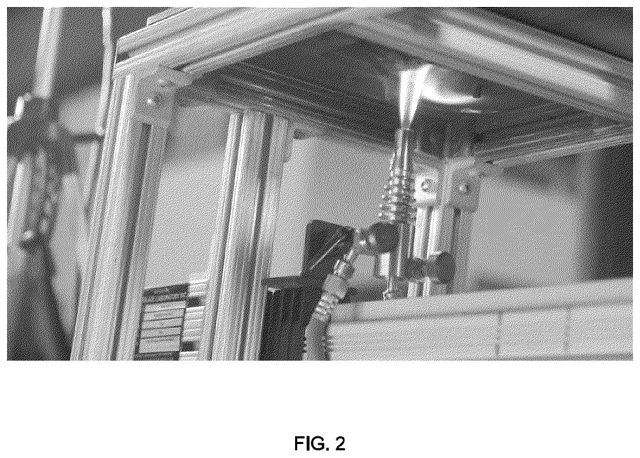

Referring now to FIG. 2, there is depicted the flexible elastomeric material according to one alternative in the shape of a sheet in a test vice with an oxy propane torch at 1200° C. at one side thereof after 30 minutes and no breakthrough of the flexible elastomeric material.

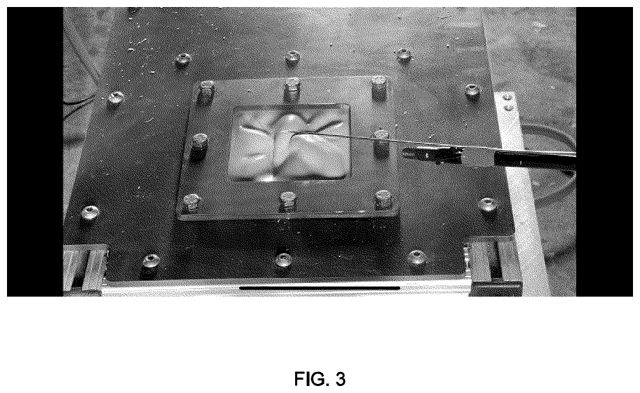

Referring now to FIG. 3, there is depicted the opposite side (i.e. the cold side) of the flexible elastomeric material of FIG. 2 according to one alternative in the shape of a sheet in a test vice with an oxy propane torch at 1200° C. at one side thereof after 30 minutes and no breakthrough of the flexible elastomeric material with a temperature below about 325° C. after 30 minutes of the flame side being exposed to a 1200° C. oxy propane torch.

### Example 1 Manufacturing Process of an Elastomeric Flexible Material from a Siloxane Gum

In this example, the flexible elastomeric material was manufactured by starting from a polysiloxane gum with a 0.15 mole % vinyl content. All raw material ingredients are weighed according to the desired formulation of the final composition. Weights are based on parts per hundred of siloxane gum used in the formulation.

Siloxane gum is added to the rolls of a two-roll mixing mill with the rolls of the mill being temperature controlled by way of a Temperature Control Unit (TCU) which uses recirculated water or coolant pumped to the interior of the mixing rolls.

Temperature of the rolls of the mill shall be controlled to ensure that the siloxane gum does not rise to a temperature during the mixing process that compromises the mixing process.

The siloxane gum is first banded on the mill with a rolling bank of silicone between the rolls to facilitate effective dispersion of the ingredients. The first ingredient added to the gum is silanol viscosity control fluid. Upon full dispersion of the silanol viscosity control fluid, fumed silica of 200 square meters per gram surface area is added next, followed by all remaining ingredients including the flux agent, glass fibre, Mica, and silicon carbide whiskers, and in one alternative a mixture of silicon carbide whiskers and wollastonite at a ratio of silicon carbide whiskers:wollastonite from about 30:0 and 20:10 PPH, and in another alternative in a ratio of from about 30:0 to 0:30 PPH of silicon carbide whiskers:wollastonite.

As an alternative to mixing the siloxane gum with the silanol viscosity control fluid and with the fumed silica, a siloxane base comprising siloxane gum, silanol viscosity control fluid and fumed silica may be used as a commercially available base.

To facilitate uniform mixing, cross-blending of the mixture is done, the above mixture is taken off of the mill in sheet form, using a doctor blade on the mill, the mixture is turned 90° and added back to the mill rolls and banded as understood by a person of ordinary skill. This step is to be repeated 6-8 times for a total additional mixing time of approximately five minutes. The last ingredients to be added to the two-roll mill are the peroxide crosslinker and if specified in the formulation an optional colour pigment may also be added.

Once the peroxide crosslinker and optional colour pigment are fully dispersed the mixture is to be further cross blended between 6-8 times. If an addition cure system is used in lieu of the peroxide crosslinker, any of the hydride crosslinker, cure inhibitor, and platinum catalyst are added to the mill and fully dispersed using the same method of cross-blending as described above. For a process wherein the peroxide crosslinker is not used and an addition cure system is used, upon full dispersion, there is a time period from about one week to 3 months, depending on the cure inhibitor effectiveness, is available to proceed to with the mixture to the next step of the process.

The mixture is removed from the two-roll mill in sheet form and left for 24 hours prior to conversion by molding, calendaring, or extrusion as understood by a person of ordinary skill in the art.

A 10-gram sample is taken from the mixture and an isothermal cure curve is generated using a Moving Die Rheometer set to 175° C. The Isothermal cure curve is used to establish the rate of reaction of the peroxide with the vinyl groups attached to the silicone polymer chain. With peroxide, the mixture will have an isothermal time to 90% cure at 175° C. of between 1.9 and 2.1 minutes. With a platinum catalyzed methyl hydrogen curing system the time to 90% cure is 1.1 minutes. Processing safety is also measured based during isothermal cure testing, processing safety is 0.47 minutes for peroxide and 0.25 minutes for platinum catalyzed methyl hydrogen curing.

The mixture is aged for 24 hours and placed back onto the two-roll mill and banded on the rolls to achieve a thickness of between 2.5 and 3 millimeters in order to prepare a “pre-form” for high temperature compression molding of a test slab of 600 mm×600 mm×2 mm thickness. A 400 mm×400 mm square piece is cut from the uncured mixture on the roll of the mill using a knife to achieve a weight of the pre-form of between 70 and 80 grams.

The 70-80-gram pre-form is taken and placed between the upper and lower halves of a steel mold which produces a 600 mm×600 mm×2 mm test slab. The pre-form is placed in the mold, the mold is placed on heated platens of a compression molding machine where the platen temperature is 175° C., the compression molding machine is closed under hydraulic pressure until a total clamp tonnage of 15-30 tons is applied to the mold. The mold remains under pressure and temperature for a period of time between 10 and 20 minutes in order to crosslink the siloxane polymer. At the completion of the molding cycle the fully cured test slab is removed from the mold and allowed to cool to room temperature.

The test slab is post cured in a hot air oven at a temperature of 200° C. for between 2 and 4 hours to remove volatile low molecular weight polysiloxane oligomers from the mixture and to complete the curing process.

Test slabs produced in this manner generate tension properties of the flexible elastomeric material including the Tensile Strength, Modulus, Elongation as per ASTM D412, and Tear Strength as per ASTM D624 “B”. Additionally, a measurement is made of the Durometer of the material using a Shore “A” Durometer as per ASTM D2240.

The mixed and fully crosslinked silicone elastomer compound has a specific gravity of 1.62, Shore A Durometer reading of 75 as per ASTM D2240, Tensile Strength of 5.3 MPa as per ASTM D412, Elongation as per ASTM D412 at break of 131%, Modulus at 100% Elongation as per ASTM D412 of 5.1 MPa and Tear Strength as per ASTM D624 “B” of 14.9 Kn/m.

Test slabs of the same length, width and thickness are subjected to direct contact with the flame of an Oxy Propane torch measured by thermocouple at 1200° C., for 30 minutes without breakthrough of the test slab by the flame. In another alternative, test slabs of the same length, width and thickness are subjected to direct contact with the flame of an Oxy Propane torch measured by thermocouple at 1400° C., for 30 minutes without breakthrough of the test slab by the flame.

In an alternative process, a siloxane base is used in the manufacture of the flexible elastomeric material, wherein the siloxane base comprises a siloxane gum, a silica reinforcing filler and a viscosity control agent and proceeding to add the remaining ingredients including the flux agent, glass fibre, Mica, and silicon carbide whiskers, and in one alternative a mixture of silicon carbide whiskers and wollastonite at a ratio of silicon carbide whiskers:wollastonite from about 30:0 and 20:10 PPH, and in another alternative in a ratio of from about 30:0 to 0:30 PPH of silicon carbide whiskers:wollastonite. In one alternative the siloxane base is allowed to rest for about 24-48 hours prior to adding the remaining ingredients including the flux agent, glass fibre, Mica, and silicon carbide whiskers, and in one alternative a mixture of silicon carbide whiskers and wollastonite at a ratio of silicon carbide whiskers:wollastonite from about 30:0 and 20:10 PPH, and in another alternative in a ratio of from about 30:0 to 0:30 PPH of silicon carbide whiskers:wollastonite.

According to yet another alternative, the process comprises starting with a siloxane base compound comprising a siloxane gum and a pre-treated silica reinforcing filler which eliminates the need for a viscosity control agent. In one alternative, the pre-treated silica reinforcing silica filler is a reinforcing filler treated with hexamethyldisilazane (HMDS) and proceeding to adding the remaining ingredients including the flux agent, glass fibre, Mica, and silicon carbide whiskers, and in one alternative a mixture of silicon carbide whiskers and wollastonite at a ratio of silicon carbide whiskers:wollastonite from about 30:0 and 20:10 PPH, and in another alternative in a ratio of from about 30:0 to 0:30 PPHof silicon carbide whiskers:wollastonite. In one alternative the siloxane base is allowed to rest for about 24-48 hours prior to adding the remaining ingredients including the flux agent, glass fibre, Mica, and silicon carbide whiskers, and in one alternative a mixture of silicon carbide whiskers and wollastonite at a ratio of silicon carbide whiskers:wollastonite from about 30:0 and 20:10 PPH, and in another alternative in a ratio of from about 30:0 to 0:30 PPH of silicon carbide whiskers:wollastonite.

The viscosity control agent is used to treat the silica reinforcing filler because the filler is hydrophilic and will react with the siloxane gum which impairs the processability of the siloxane base. The viscosity control agent works “in-situ” when added to the two-roll mill, physically contacting the surface of the silica reinforcing filler and converting the surface from being hydrophilic to hydrophobic. Hydrophobic silica is less able to react with the siloxane gum. Pre-treating the silica reinforcing filler with hexamethyldisilazane results in the silica reinforcing filler to be hydrophobic, eliminating the need for a viscosity control agent.

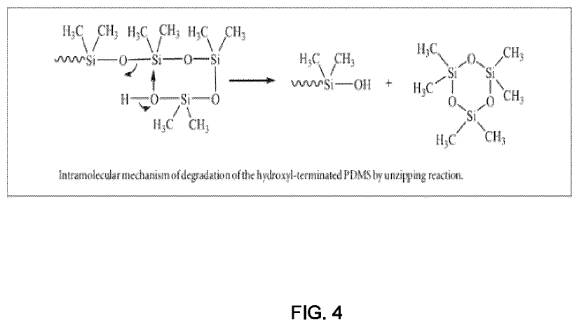

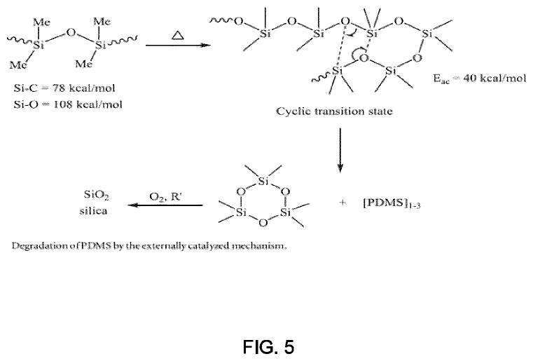

During the eutectic formation, phase 1, it is the understanding that the flexible elastomeric material when exposed to temperatures above 400° C. will begin to undergo random chain breaking reactions as best seen in FIG. 4 due to the presence of residual polymerization catalysts or polar additives. Silicone oligomers are generated, which under conditions of pyrolysis are converted to SiO₂ under 1200° C. ablation conditions, as best seen in FIG. 5.

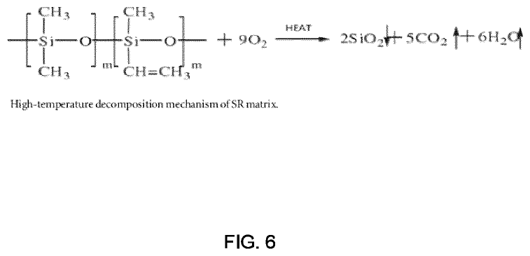

In relation to high temperature decomposition by-products, the flexible elastomeric material described herein, in one alternative, does not contain halogen-based flame retardants since chlorine and bromine based flame retardants generate large amounts of toxic gases such as CO, SO₂, H₂S and HCN as well as black smoke. In one alternative, the main decomposition by-products produced by the flexible elastomeric material described herein are CO2 and H₂O (See FIG. 6).

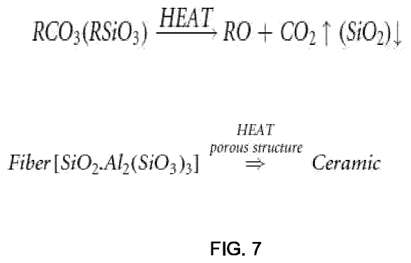

At the creation of the ceramic eutectic mixture, phase 2, the PDMS decomposes into silicon dioxide during combustion, and a molten eutectic mixture is formed between the silicon dioxide and the refractory fillers used herein resulting is a self-supporting, dense ceramic material (See FIG. 7) with properties such as, but not limited to flame retardancy, fireproof and high temperature resistant ceramic which block the flame from breakthrough.

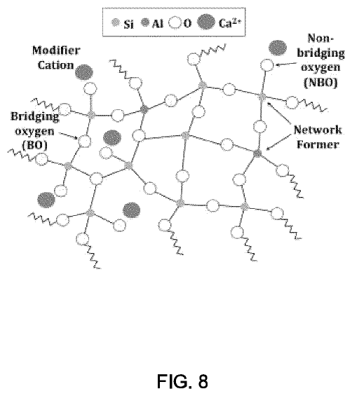

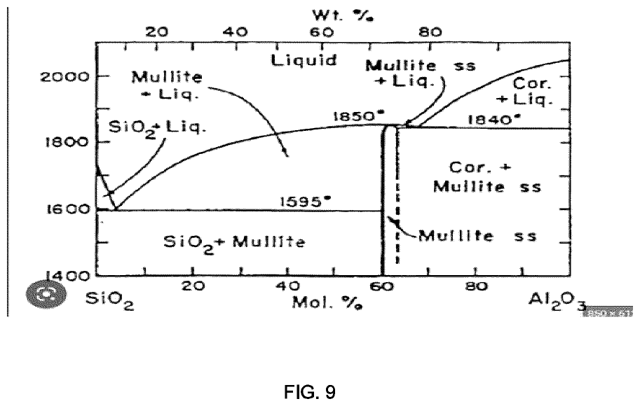

During phase 2, the molten eutectic mixture is formed. The chemical structure of an aluminosilicate (Al₂O₃·SiO₂) eutectic mixture is provided in FIG. 8 and the aluminosilicate binary system phase diagram is provided in FIG. 9, according to one alternative.

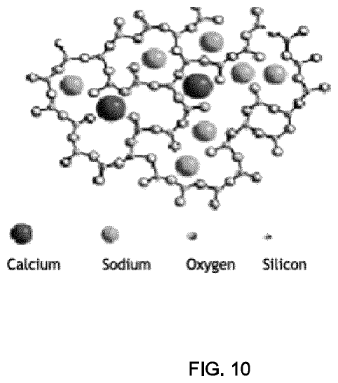

The chemical structure of the eutectic mixture is provided in FIG. 10.

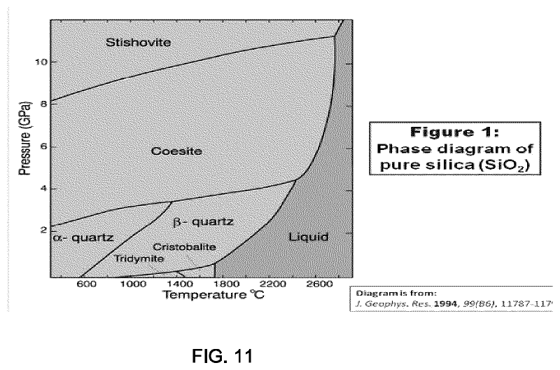

The SiO₂ polymorphic eutectic phase diagram is provided in FIG. 11.

In the formation of the glass/ceramic eutectic mixture, according to one alternative, zinc borate is used as a flux agent lowering the melting point of the glass and ceramic powders so that the glass and ceramic powders may form a eutectic mixture at a temperature lower than the melting points of the glass and ceramic powders. Zinc borate also serves to provide waters of hydration serving to quench flames from the autoignition of the elastomer material before the glass/ceramic eutectic mixture is formed, stopping the flames from puncturing the elastomer material. Zinc borate also serves as a fire retardant due to the waters of hydration.

In one alternative, the grade of zinc borate used herein has a median particle size of 2.1 microns. The following is a schematic representation of the theoretical chemical composition of zinc borate hydrate 2ZnO₃B₂O₃3.5H₂O:
h. Boric oxide 48.05 w/w %
i. Zinc oxide 37.44 w/w %
j. Water 14.51 w/w %
k. Anhydrous equivalent 2ZnOB₂O₃ 85.49 w/w %.

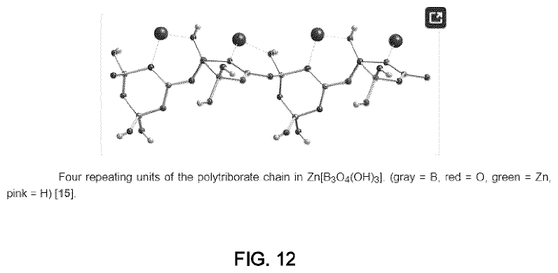

FIG. 12 depicts four repeating units of the polytriborate chain in Zn[B₃O₄(OH)₃].

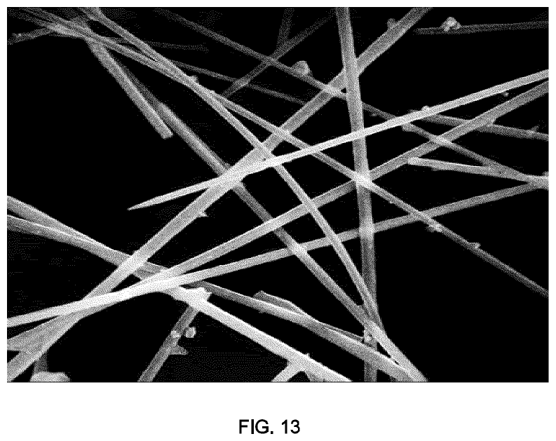

FIG. 13 depicts a scanning electron microscopic (SEM) photo of silicon carbide whiskers. The role of the silicon carbide whiskers in the eutectic ceramic mixture is to reinforce the ceramic materials in the eutectic ceramic mixture. The 15:1 “aspect ratio” silicon carbide whiskers are calcined on the surface providing a durable silica monolayer with enhanced wettability and physical adhesion to the aluminosilicate enhancing mechanical integrity of the eutectic mixture under the pressure from the oxyacetylene flame.

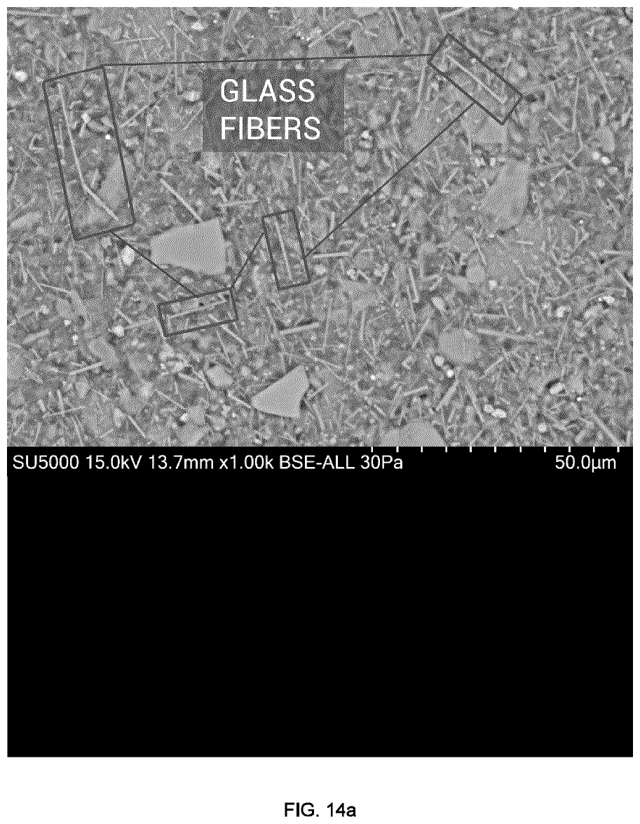

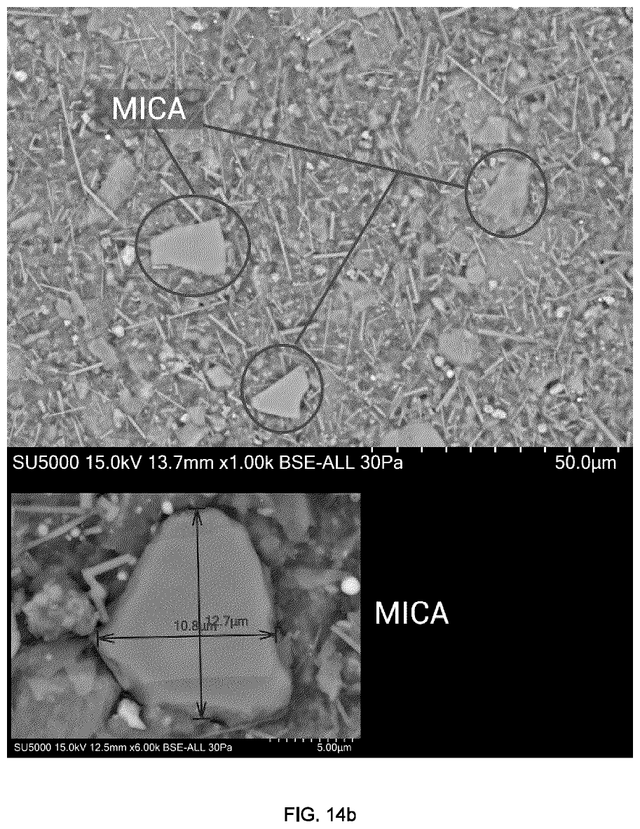

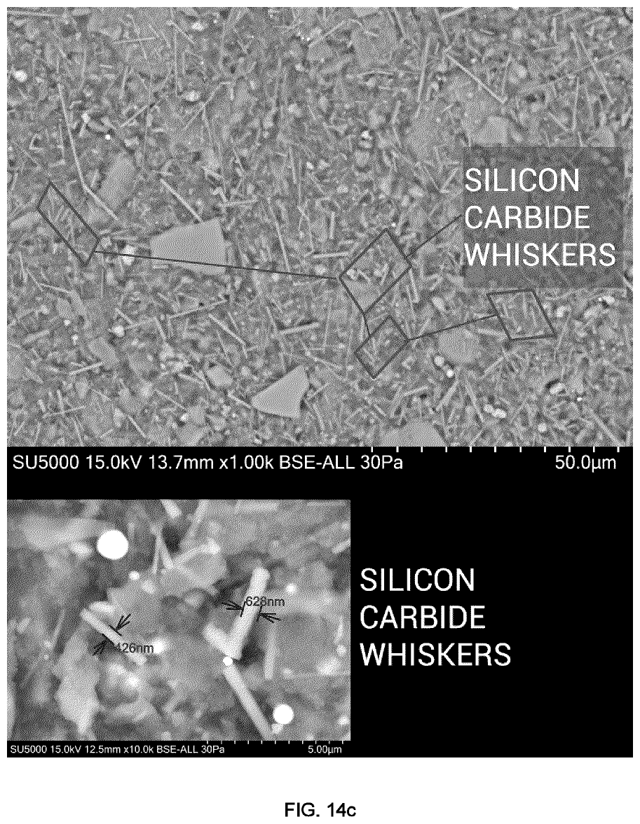

FIGS. 14a, 14b and 14c depict a SEM photograph of the flexible elastomeric material as described herein prior to exposure to 1200° C. flame. The glass fibers may be seen in FIG. 14a, the mica may be seen in FIG. 14b and the silicon carbide whiskers may be seen in FIG. 14c, wherein the glass, mica and silicon carbide whiskers are visible.

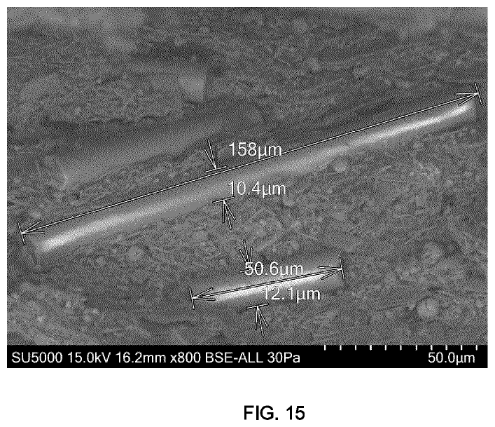

FIG. 15 depicts a SEM photograph of the flexible elastomeric material as described herein at point of exposure to 1200° C. flame. The glass fiber remains intact and is visible under magnification.

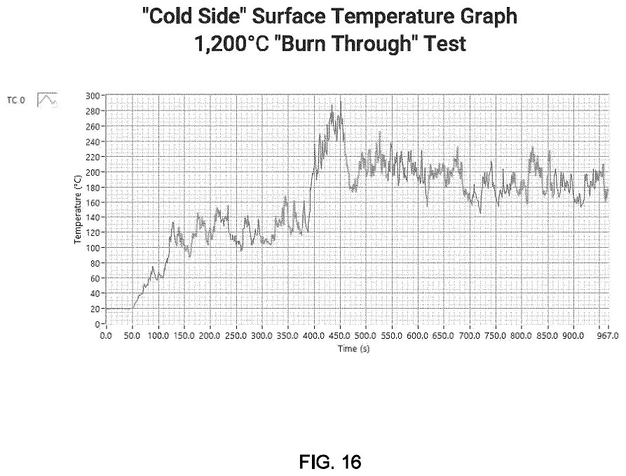

FIG. 16 depicts the rate of temperature rise of the cold side of the flexible elastomeric material exposed to a 1200° C. flame versus time. It can be seen the temperature remains well below 300° C. for up to 30 minutes.

### Example 2 Manufacturing Process of an Elastomeric Flexible Material from a Siloxane Base

Add the Silicone Rubber Shin-Etsu® Base Polymer SV13500U to the mill to form a bank between the two rolls of the Two Roll Mill.

Add Fibertec 9132 glass fibers to the mill and disperse by cross blending 5-6 times.

Add Zn Borate ZB Fine to the mill and end mill 4-6 times or until fully dispersed.

Add Mica SA20 to the mill and crossblend 4-6 times until particles are fully dispersed.

Add SiC SF1 whiskers to the mill. The mixture will start to crumble and fall off the mill. Gather the pieces from the pan of the mill and add back to mill nip by crossblending multiple times or until no SiC filler has fallen into the pan of the mill.

Add the peroxide KriCure 130V and mill until completely dispersed in the mixture, crossblended 6-8 times.

Temperature control of the mill is important to prevent unwanted crosslinking. Chilling of the rolls is required during mixing. Open valve of HB-Therm Thermoregulator to maintain sufficient cooling of the mixture so that the temperature is not higher than 60° C.

The following amounts of the ingredients were used for Example 2.

| | |
|---|---|
| Shin-Etsu ® Base Polymer SV13500U | 700 gm |
| Zn Borate Firebrake fine | 105 gm |
| Fibertec 9132 Glass Fiber | 140 gm |
| Muscovite Mica SA20 | 280 gm |
| Si-Tuff SF1 Silicon Carbide | 210 gm |
| Kricure 130V Peroxide | 7 gm |
| TOTAL | 1442 gm |

The following is the resultant amounts in the final flexible elastomeric material from example 2:

| Ingredients | PPH | Parts by weight |
|---|---|---|
| Shin-Etsu ® Base Polymer SV13500U | 100 | 48.37 |
| Zn Borate Firebrake fine | 15 | 7.26 |
| Fibertec 9132 Glass Fiber | 20 | 9.67 |
| Muscovite Mica SA20 | 40 | 19.35 |
| Si-Tuff SF1 SiC | 30 | 14.51 |
| Kri-Chem 700MR | 0.75 | 0.36 |
| Kricure 130V | 1 | 0.48 |
| TOTAL | 206.75 | 100.00 |

The flexible elastomeric material, according to one alternative, when undergoing a heat resistance test as per ASTM D573 at a test temperature of 225° C. and a test time of 70 hours, exhibits a change in Durometer as per “A” ASTM D2240 from about 9 to 1 points, a change in tensile strength as per ASTM D412 from about −8.3 to about 51.8% and a change in elongation as per ASTM D412 from about −40.6 to about −77.5%.

The flexible elastomeric material, according to one alternative, when undergoing a fluid resistance test as per ASTM D471 with a test fluid of ethylene glycol/water, a test temperature of 100° C. (reflux) and a test time of 70 hours, exhibits a change in Durometer as per “A” ASTM D2240 from about 2 to about −1 points, a change in tensile strength as per ASTM D412 from about −31.5 to −15.4%, a change in elongation as per ASTM D412 from about 13.2 to about 8.2%, and a change in volume from about 2.3 to 1.4%.

Compression set resistance refers to the flexible elastomeric material's ability to create and maintain a seal for extended periods of time at elevated temperatures as to provide fire resistance performance during an unexpected thermal event. The flexible elastomeric material, according to one alternative, when undergoing a compression set test as per ASTM D395 “B” with a test temperature of 150° C. and a test time of 70 hours, exhibits a compression set from about 47.7 to about 27.6. The flexible elastomeric material, in one alternative, exhibits a volume resistivity as per IEC62631-3-1 from greater than about 10¹³ to 8.01×10¹⁵ ohm·cm. The flexible elastomeric material, in one alternative, exhibits a dielectric strength as per IEC60243-1 from about 10.6 to 12 kV/mm. The flexible elastomeric material, in one alternative, exhibits a temperature of retraction as per TR10 C° ASTM D1329-02 from about 40 to 0 at −40° C. The flexible elastomeric material, in one alternative, exhibits a thermal conductivity from about 0.8044 to 0.6964. Prior to a thermal event, the flexible elastomeric material, in one alternative, is 3.5× more conductive than a standard silicone elastomer allowing thermal energy to be transmitted to mating thermal management components (i.e. heat sink). The flexible elastomeric material, in one alternative, exhibits a thermal effusivity from about 1171.92 to 1074.14 Ws^{1/2}/m2K. The flexible elastomeric material, in one alternative, exhibits a flammability rating as per UL 94 and aged 168 hours at 70° C. of V-0. The flexible elastomeric material, in one alternative, exhibits fire resistance and no burn through at 30 minutes at 1200° C. with a laminar flow oxy-propane nozzle.

### Example 3 Testing of a Flexible Elastomeric Material with a Silicon Carbide: Wollastonite Filler

The following formulation with a 20:10 silicon carbide: wollastonite ratio was prepared as per the above.

| Ingredient | PPH | Weight % |
|---|---|---|
| Shin-Etsu ® Base Polymer SV13500 | 100 | 48.54 |
| Silicone Base | | |
| Zinc Borate ZB Firebrake Fine | 15 | 7.28 |
| Fibertec 9132 Glass Fiber | 20 | 9.71 |
| Silicon Carbide Whiskers Si-Tuff SF1 | 20 | 9.71 |
| Nyad ″G″ Wollastonite | 10 | 4.85 |
| Muscovite Mica SA20 | 40 | 19.42 |
| KriCure 130V Peroxide | 1 | 0.49 |
| | 206 | 100.00 |

### Example 4: Formulations Under Mechanical Retention with a Silicon Carbide: Wollastonite Filler were Tested for Burn Through by the Application of a 1200° C. Oxyacetylene Flame and the Following Results were Achieved

| | Peak | Peak | | | | | | | | | |
|---|---|---|---|---|---|---|---|---|---|---|---|
| | Backside | Backside | | | | Burn | | | | | |
| | Temper- | Temperature | Topside | Topside | | Through | | | | | |
| | ature | Time | Ignition? | ignition | Burn | Time | | | | | |
| Sample | (PBT) | (PBTT) | (TI) | time (TT) | Through? | (BTT) | T100 | T200 | T400 | T600 | T900 |
| # | C° | seconds | (Y/N) | (Seconds) | (Y/N) | (seconds) | (C°) | (C°) | (C°) | (C°) | (C°) |
| 1 | 156.3 | 222 | N | N/A | N | N/A | 125.8 | 121.4 | 127.6 | 104.3 | 103.4 |
| 2 | 131.9 | 526 | N | N/A | N | N/A | 93.6 | 117.9 | 98.6 | 92 | 104.9 |
| 3 | 139.6 | 193 | N | N/A | N | N/A | 86.1 | 119.9 | 92.8 | 104.9 | 96.7 |
| 4 | 198.3 | 167 | N | N/A | N | N/A | 170.6 | 168.4 | 156.4 | 104.7 | 128.7 |

Samples 1 and 2 had a wollastonite: SiC ratio of 5:25 PPH and samples 3 and 4 had a wollastonite: SiC ratio of 10:20 PPH. All samples were exposed to a 1200° C. flame on the topside for 30 minutes under mechanical retention of the samples not allowing for any linear thermal expansion. Mechanical retention may be seen in FIG. 3. A 7″×7″×¼″ thick metal plate with a 4″×4″ cutout to expose the sample to the flame is placed over the sample and secured in place by tightened bolts. The peak backside temperatures did not exceed 389° F. and there was no topside ignition, the topside being the side of the 1200° C. flame and there was no burn through although the temperature changed slightly.

### Example 5: Formulations with a Silicon Carbide: Wollastonite Filler were Tested for Burn Through by the Application of a 1200° C. Oxyacetylene Flame Under Weight Retention and the Following Results were Achieved

| | Peak | Peak | | | | | | | | | |
|---|---|---|---|---|---|---|---|---|---|---|---|
| | Backside | Backside | | | | Burn | | | | | |
| | Temper- | Temperature | Topside | Topside | | Through | | | | | |
| | ature | Time | Ignition? | ignition | Burn | Time | | | | | |
| Sample | (PBT) | (PBTT) | (TI) | time (TT) | Through? | (BTT) | T100 | T200 | T400 | T600 | T900 |
| # | C° | seconds | (Y/N) | (Seconds) | (Y/N) | (seconds) | (C°) | (C°) | (C°) | (C°) | (C°) |
| 1 | 108.2 | 81.1 | N | N/A | N | N/A | 68.2 | 79.8 | 72.4 | 69.8 | 67.2 |
| 2 | 64.4 | 58.3 | N | N/A | N | N/A | 48.1 | 44.9 | 51.8 | 42 | 41.8 |
| 3 | 79.3 | 41.1 | N | N/A | N | N/A | 57.8 | 62.5 | 50.1 | 47.1 | 54.1 |
| 4 | 95.5 | 231 | N | N/A | N | N/A | 90.9 | 63.8 | 77.3 | 53.8 | 61.7 |

Samples 1 and 2 had a wollastonite: SiC ratio of 15:15 PPH and samples 3 and 4 had a wollastonite: SiC ratio of 30:0 PPH. All samples were exposed to a 1200° C. flame on the topside for 30 minutes under weight retention of the samples allowing for linear thermal expansion of the sample throughout the process. Weight retention involved the sample held in place by the weight of the securing plate without fastening the plate to the test surface (i.e. FIG. 3 but without the bolts securing the securing plate onto the sample and test surface). The 7″×7″×¼″ thick metal plate with a 4″×4″ cutout to expose the sample to the flame was placed over the sample without bolts and the weight of the plate kept the sample in place during testing. The peak backside temperatures did not exceed 389° F. and there was no topside ignition, the topside being the side of the 1200° C. flame and there was no burn through although the temperature changed slightly.

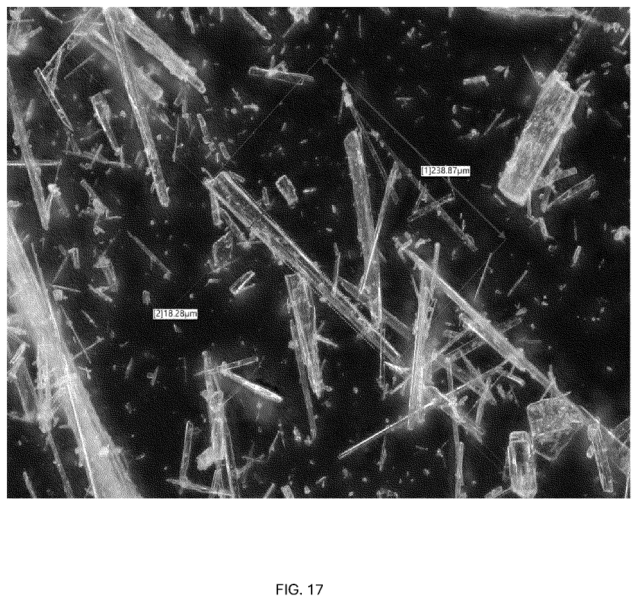

Referring now to FIG. 17, there is depicted wollastonite showing typical measurements of length at 1 (238.87 μm) and diameter at 2 (18.28 μm), exemplifying the length to diameter ratio L/D of wollastonite.

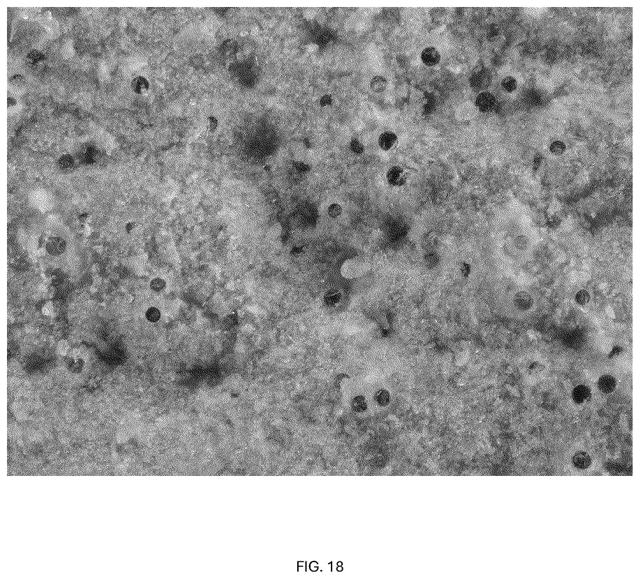

Referring now to FIG. 18, there is depicted a cross section of the flexible elastomeric material with wollastonite and silicon carbide in the material.

Possible uses of the flexible elastomeric material include, but are not limited to:

### Electric Vehicles (EV)

Lithium Ion Battery enclosures to prevent thermal runaway from one cell of the battery to adjacent cells. The flexible elastomeric material is able to withstand direct contact with a 1200° C. flame. Correspondingly, the flexible elastomeric material maintains flexibility as low as −40° C.

Elastomeric sealing of the passenger compartment during a thermal event, thereby mitigating flame and smoke entry into the vehicle, allowing vehicle occupants time to escape.

Elastomeric sealing systems in wiring systems, and specifically electrical connectors which provide power to control functions of the vehicle such as electrically operated doors and windows.

Seals for thermal management fluids which must be resistant to the temperature during a thermal runaway.

### Railway Cars

Prevent flame and smoke from spreading from one rail car to an adjacent car in the event of a fire when the flame is 1200° C. for 30 minutes.

Elastomeric seals in electrical wiring systems, and specifically electrical connectors which provide power to control functions of the vehicle such as electrically operated doors and windows.

### Passenger Aircraft

Elastomeric sealing of components of the electrical system of aircraft to make them fire resistant and allow electrical function of mechanical components in the event of a thermal event such as a fire in a fuel tank or engine.

Seal the passenger compartment of an aircraft from direct contact with smoke.

### Fire Safety Cables

Provide fire resistance as high as 1400° C. to cable used in alarm systems, emergency lighting, ventilation, and automatic doors on escape routes.

### Fire Resistant Clothing

The flexible elastomeric material may be used to coat textiles and to convey flame resistance to articles made from a coated textile.

As many changes can be made to the preferred alternative of the disclosure without departing from the scope thereof; it is intended that all matter contained herein be considered illustrative and not in a limiting sense.

1-36. (canceled)

37. A flexible elastomeric material comprising:
a. at least one siloxane gum in an amount selected from the group consisting of: from about 30-60% by weight (w/w), from about 38-48% by weight (w/w), from about 42% by weight (w/w), from about 41% by weight (w/w) and combinations thereof, of said flexible elastomeric material;
b. at least one silica reinforcing filler in an amount selected from the group consisting of from about 5-30% w/w, from about 10-20% w/w, 12% w/w and combinations thereof;
c. at least one silica extending filler selected from the group consisting of from about 0-50% w/w, from about 0-30% w/w and combinations thereof;
d. at least one viscosity control agent in an amount selected from the group consisting of: from about 0.5-10% w/w, from about 0.5-5% w/w, from about 0.5-30% w/w, 2% w/w, 2.1% w/w and combinations thereof;
e. at least one flux agent in an amount selected from the group consisting of: from about 1-25% w/w, from about 3-15% w/w, from about 1-5% w/w, 6% w/w and combinations thereof;
f. at least one glass fibre filler in an amount selected from the group consisting of: from about 5-40% w/w, from about 5-15% w/w, 8% w/w and combinations thereof;
g. at least one hydrous aluminum silicate filler in an amount selected from the group consisting of: from about 5-30% w/w, 5-20% w/w; 17% w/w, 16% w/w and combinations thereof;
h. at least one silicon carbide filler in an amount selected from the group consisting of: from about 20-40% w/w, from about 5-15% w/w, 12% w/w and combinations thereof; and
i. at least one peroxide crosslinker in an amount selected from the group consisting of: from about 0.1-0.6% w/w, from about 0.2-0.4% w/w, 0.3% w/w and combinations thereof,
wherein components a, b, and c form a siloxane base of the flexible elastomeric material.

38. The flexible elastomeric material of claim 37, wherein the silica reinforcing filler is nano silica.

39. The flexible elastomeric material of claim 37, wherein the peroxide crosslinker is selected from 2,5 dimethyl, 2,5 di (t-butyl peroxy)-hexane or 2,4 dichlorobenzoyl peroxide.

40. The flexible elastomeric material of claim 37, wherein the at least one silicon carbide filler is substituted with a silicon carbide: wollastonite filler at a ratio of 30:0 to 0:30 parts per hundred of siloxane base (PPH).

41. The flexible elastomeric material of claim 37, further comprising at least one cure inhibitor in an amount selected from the group consisting of: from about 0.02-0.06% w/w, 0.02-0.04% w/w, 0.04 w/w and combinations thereof.

42. The flexible elastomeric material of claim 37, further comprising at least one platinum complex catalyst in an amount selected from the group consisting of: from about 0.01-0.05% w/w, from about 0.015-0.03% w/w, 0.02% w/w and combinations thereof.

43. The flexible elastomeric material of claim 37, further comprising at least one methyl hydrogen fluid crosslinker in an amount selected from the group consisting of: from about 0.01-0.05% w/w, 2.0% w/w and combinations thereof.

44. The flexible elastomeric material of claim 37, wherein the at least one siloxane gum comprises polydiorganosiloxane having organic radicals selected from methyl, vinyl, phenyl, 3,3,3-trifluoropropyl, and mixtures thereof.

45. The flexible elastomeric material of claim 37, wherein the at least one viscosity control agent is a hydroxyl terminated silanol fluid.

46. The flexible elastomeric material of claim 37, wherein the at least one hydrous aluminum silicate filler is selected from ground muscovite, phlogopite mica, or combinations thereof.

47. The flexible elastomeric material of claim 37, wherein the at least one glass fibre filler is E-glass filament.

48. A process for manufacturing a flexible elastomeric material, comprising:
a. mixing a siloxane gum with a viscosity control agent;
b. dispersing a silica reinforcing filler into the mixture to form a siloxane base;
c. adding a flux agent, a glass fibre filler, a hydrous aluminum silicate filler, and a silicon carbide filler;
d. mixing the components of step c;
e. adding a peroxide crosslinker;
f. forming the mixture of step e into a sheet;
g. molding the sheet under pressure; and
h. cooling and post-curing.

49. The process of claim 48, wherein the mixing step is performed using a two-roll mill.

50. The process of claim 48, the mixing step is performed using a two-roll mill and wherein at least one roll is temperature-controlled to below 60° C.

51. The process of claim 48, wherein cross-blending occurs after addition of all fillers and before crosslinker addition.

52. The process of claim 48, wherein the peroxide crosslinker is replaced by a combination of a platinum catalyst, a hydride crosslinker, and a cure inhibitor.

53. The process of claim 48, further comprising adding a color pigment during or after addition of the peroxide crosslinker.

54. The flexible elastomeric material of claim 37, having at least one of the following characteristics:
a. specific gravity of 1.62;
b. Shore A durometer hardness of 75;
c. tensile strength of 5.3 MPa;
d. elongation at break of 131%;
e. modulus at 100% elongation of 5.1 MPa;
f. tear strength of 14.9 kNm-1; and
g. breakthrough resistance at 1200° C. for 30 minutes.

55. A flexible elastomeric material formed by the process of claim 48, having a Shore A hardness from 70 to 71, a tensile strength from 4.6 to 5.5 MPa, and elongation at break from 88% to 147%.

56. The process of claim 48, wherein the starting material is a pre-mixed siloxane base comprising siloxane gum, silica filler, and viscosity control agent.

57. The process of claim 48, wherein the silicon carbide filler is substituted with a silicon carbide: wollastonite filler with a silicon carbide: wollastonite ratio of from 30:0 to 0:30 PPH.
